(19) United States
(12) Patent Application Publication
(10) Pub. No.: US 2017/0060750 A1
(43) Pub. Date: Mar. 2, 2017

(54) CACHE WAY PREDICTION USING PARTIAL TAGS

(71) Applicant: QUALCOMM Incorporated, San Diego, CA (US)

(72) Inventors: Anil KRISHNA, Raleigh, NC (US); Gregory Michael WRIGHT, Chapel Hill, NC (US); Derek Robert HOWER, Durham, NC (US)

(21) Appl. No.: 14/843,958

(22) Filed: Sep. 2, 2015

(51) Int. Cl. G06F 12/08

(52) U.S. Cl. CPC G06F 12/0862; G06F 2212/1021; G06F 2212/602

(57) ABSTRACT

Method and apparatus for cache way prediction using a plurality of partial tags are provided. In a cache-block address comprising a plurality of sets and a plurality of ways or lines, one of the sets is selected for indexing, and a plurality of distinct partial tags are identified for the selected set. A determination is made as to whether a partial tag for a new line collides with any of the partial tags for current resident lines in the selected set. If the partial tag for the new line does not collide with any of the partial tags for the current resident lines, then there is no aliasing. If the partial tag for the new line collides with any of the partial tags for the current resident lines, then aliasing may be avoided by reading the full tag array and updating the partial tags.

### FIELD OF DISCLOSURE

Various embodiments described herein relate to cache memory, and more particularly, to efficient cache way prediction with reduced probability of aliasing.

### BACKGROUND

Cache memories have been implemented in microprocessors to allow instantaneous or nearly instantaneous access for read and write operations by algorithmic circuitries within the microprocessors. A typical requirement for a cache memory is fast and efficient access to a given cache memory location in a microprocessor. Various schemes have been devised for fast and efficient access to cache memory. For example, a conventional microprocessor may include a set-associative cache memory in which a tag lookup scheme may be used to determine the correct line address in a two-dimensional tag array.

A conventional set-associative microprocessor cache may include a number of sets, each set containing a number of lines, also known as blocks. Each line or block in a given set is also called a “way.” In a typical full tag array lookup scheme, a set is selected using a deterministic hash of an incoming probe line address, for example, with a simple bit slice of the line address. In the selected set, the full probe address, called a tag, is compared to a stored line address in each of the ways to determine if the line is resident in the cache. Thus, for an N-way associative cache, a full tag array lookup would require N full tag comparisons.

A data array having the same number of sets and the same number of ways in each set as in the corresponding full tag array is provided for data storage and retrieval. Various schemes have been devised for data lookup in a two-dimensional array. Although the tags help locate the correct line, it is the data associated with the line that is usually of primary interest. Data reading may be performed by using either a parallel lookup cache or a sequential lookup cache, for example.

In a typical parallel lookup cache, the data is accessed at the same time as the tags. All of the ways in a data array set need to be accessed in a parallel lookup cache because the tag comparison has not completed before the data array is accessed. Although data access may be relatively fast in a typical parallel lookup cache, energy may be wasted on the non-matching ways. In a typical sequential lookup cache, the data array is accessed after the tag comparison is complete. Although wasted energy may be reduced in a typical sequential lookup cache by accessing only the matching ways in a set, the overall access time of the cache is increased due to non-simultaneous performance of data array access and tag comparison.

To balance the competing demands of fast access and energy efficiency, cache way prediction schemes have been proposed to improve the speed of access over a conventional sequential lookup cache and to improve the energy efficiency over a conventional parallel lookup cache. In a typical way-predicted cache, the matching way in a set is predicted before the full tag comparison is complete. If the prediction is correct, the correct way in the data array can be accessed in parallel with the full tag comparison. In an ideal situation, a way-predicted cache would be able to perform data access at a speed comparable to a conventional parallel lookup cache with energy comparable to a conventional sequential lookup cache.

In contrast to a determinative scheme, a predictive scheme may not always produce an accurate result. In a typical way-predicted cache, way mis-predictions may result in a penalty in cache lookup. To avoid such a penalty, a follow-on full lookup may be attempted, for example, after the way predictor is updated with the correct information. Such a scheme of follow-on full lookup, however, may slow down data access significantly, thereby forgoing the advantage associated with a way-predicted cache over a sequential lookup cache.

Way prediction utilizing partial tags has been devised for speed and energy efficiency. A potential problem with some conventional schemes of way prediction is aliasing. Aliasing occurs when two or more partial tags match upon a lookup. When aliasing occurs, the cache predictor needs to have a mechanism to choose among multiple partial tags that match one another. Although a way-predictive scheme may improve the speed of access by not performing a full-tag lookup, the speed of access may be degraded if aliasing occurs. For example, if multiple partial tags match one another, it would take additional time to arbitrate between them, that is, to pick one tag among the multiple matching partial tags, thereby increasing the latency of accessing the data array. Moreover, the accuracy of way prediction may suffer because it is unclear which of the aliasing ways to pick without a reliable arbitration mechanism.

Schemes have been devised to manage partial tags in attempts to resolve the problem of aliasing. In one such scheme, if a partial tag being newly established in a given set matches any existing partial tags in that set, then the new partial tag is arbitrarily modified to avoid any aliasing. For example, the new partial tag may be circularly shifted to avoid aliasing with any of the existing partial tags in the given set. While this obviates the need for multiple-hit arbitration at lookup time because multiple hits cannot happen, it may not truly resolve the problem of aliasing. It effectively renders the modified partial tag useless or, worse still, prone to false hits. After the new partial tag is modified, by circular shifting, for example, the modified partial tag may hit the corresponding partial tag of some other line being probed and not the line that installed the partial tag. This would appear to be a hit but in fact would be a false hit. While a full-tag lookup would reveal that the modified partial tag produced a false hit, by then the data array access to the predicted way would likely have started already, thereby wasting energy.

Another simpler approach to reducing aliasing is to use more bits in the partial tag. Increasing the number of partial tag bits in a multiple-way set-associative cache may decrease the probability of aliasing in the set-associative cache. Although increasing the number of bits in a partial tag may decrease the probability of aliasing, it may necessitate an increase in energy consumption and an increase in the area of the circuit for storage associated with partial tags.

### SUMMARY

Exemplary embodiments of the disclosure are directed to method and apparatus for cache way prediction using partial tags.

In an embodiment, a method of cache way prediction in a set-associative cache comprising a plurality of sets, each set comprising a plurality of lines is provided, the method comprising: selecting one of the sets for indexing; identifying which one of a plurality of hashes is currently in use for said selected one of the sets; identifying a plurality of partial tags for said selected one of the sets; determining whether a partial tag for a line being looked up in the cache matches any of the partial tags for current resident lines in said selected one of the sets; and when installing a new line in the cache, modifying the hash and partial tags in use for the said selected on of the sets upon a determination that the partial tag for the new line collides with any of the partial tags for the current resident lines in said selected one of the sets.

In another embodiment, an apparatus for cache way prediction in a set-associative cache comprising a plurality of sets, each set comprising a plurality of lines is provided, the apparatus comprising: means for selecting one of the sets for indexing; means for identifying which one of a plurality of hashes is currently in use for said selected one of the sets; means for identifying a plurality of partial tags for said selected one of the sets; means for determining whether a partial tag for a line being looked up in the cache matches any of the partial tags for current resident lines in said selected one of the sets; and means for modifying the hash and partial tags in use for the said selected on of the sets upon a determination that the partial tag for the new line collides with any of the partial tags for the current resident lines in said selected one of the sets when installing a new line in the cache.

In yet another embodiment, an apparatus for cache way prediction in a set-associative cache comprising a plurality of sets, each set comprising a plurality of lines is provided, the apparatus comprising: logic configured to select one of the sets for indexing; logic configured to identify which one of a plurality of hashes is currently in use for said selected one of the sets; logic configured to identify a plurality of partial tags for said selected one of the sets; logic configured to determine whether a partial tag for a line being looked up in the cache matches any of the partial tags for current resident lines in said selected one of the sets; and logic configured to modify the hash and partial tags in use for the said selected on of the sets upon a determination that the partial tag for the new line collides with any of the partial tags for the current resident lines in said selected one of the sets when installing a new line in the cache.

### BRIEF DESCRIPTION OF THE DRAWINGS

The accompanying drawings are presented to aid in the description of embodiments of the disclosure and are provided solely for illustration of the embodiments and not limitations thereof.

FIGS. 1A and 1B illustrate examples of a processor with an integrated cache memory and a processor with a separate cache memory, respectively.

FIGS. 2A-2D illustrate the relationships between per-set hash functions in a partial tag array, the partial tag array with W ways and S sets, the corresponding full tag array with W ways and S sets, and the corresponding data array with W ways and S sets, respectively.

FIGS. 3A and 3B illustrate tables showing the probability of collision and the storage bits per set, respectively, for a 4-way cache, that is, with an “associativity” of 4, as the number of hash functions and the number of bits per partial tag are varied.

FIGS. 4A and 4B illustrate tables showing the probability of collision and the storage bits per set, respectively, for an 8-way cache, that is, with an “associativity” of 8, as the number of hash functions and the number of bits per partial tag are varied.

FIG. 5 is a flowchart illustrating an embodiment of a method of cache way prediction in a set-associative cache.

FIG. 6 is a block diagram illustrating an embodiment of cache lookup using a partial tag array and partial tag hashers.

FIG. 7 is a block diagram illustrating an alternate embodiment of cache lookup using a partial tag array and partial tag hashers.

FIG. 8 is a block diagram illustrating an embodiment of updating the partial tag array if it is determined that a collision or aliasing occurs between a new line from a received cache-block address and current resident lines in the cache.

FIG. 9 is a block diagram illustrating an embodiment of an apparatus that includes logic configured to perform functionalities associated with embodiments of cache way prediction.

### DETAILED DESCRIPTION

Aspects of the disclosure are described in the following description and related drawings directed to specific embodiments. Alternate embodiments may be devised without departing from the scope of the disclosure. Additionally, well-known elements will not be described in detail or will be omitted so as not to obscure the relevant details of the disclosure.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein is for the purpose of describing particular embodiments only and is not intended to be limiting of the embodiments. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, and/or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Further, many embodiments are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

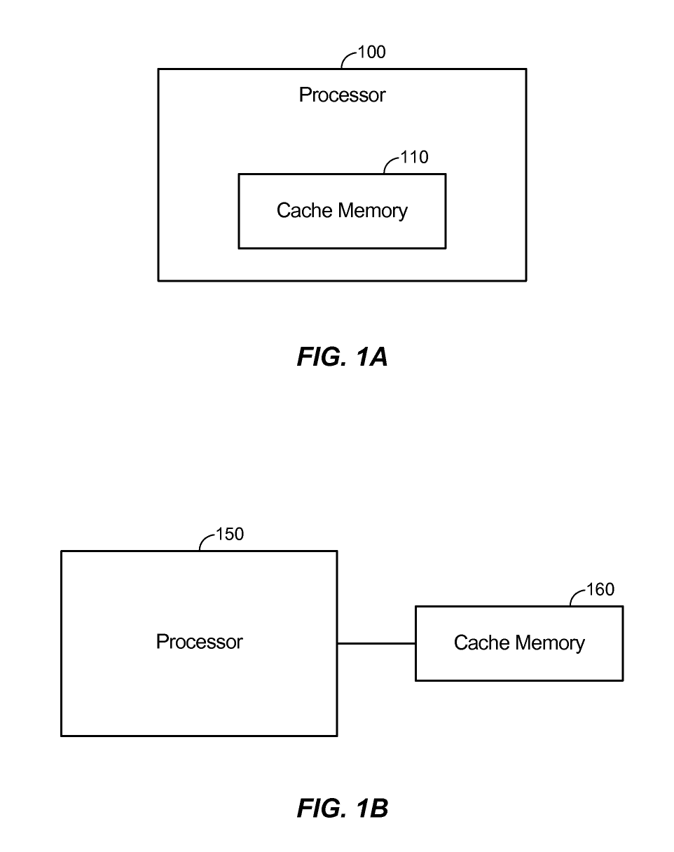

A cache is a cache used by a processor or central processing unit (CPU) of a computer to reduce the average time to access data from an external main memory. The cache is typically a smaller, faster memory which stores copies of data or instructions from frequently used external main memory locations. FIGS. 1A and 1B illustrate examples of a processor with an integrated cache memory and a processor with a separate cache memory, respectively. In the example illustrated in FIG. 1A, a cache memory 105 is provided as an integral part of a processor 100. For example, the cache memory 105 may be integrated as part of the same chip in which the circuitry for the processor 100 is implemented. FIG. 1B illustrates an alternative example in which the cache memory 160 is provided separately from the processor 150. For example, the cache memory 160 may be implemented on a chip separate from the processor 150. In such an implementation, access to the cache memory 160 is typically still faster than access to main external memory locations. Physical implementations of cache memories and processors are known to persons skilled in the art. It will be appreciated that methods and apparatus according to embodiments of the disclosure may be applied to cache memories and processors of various physical implementations.

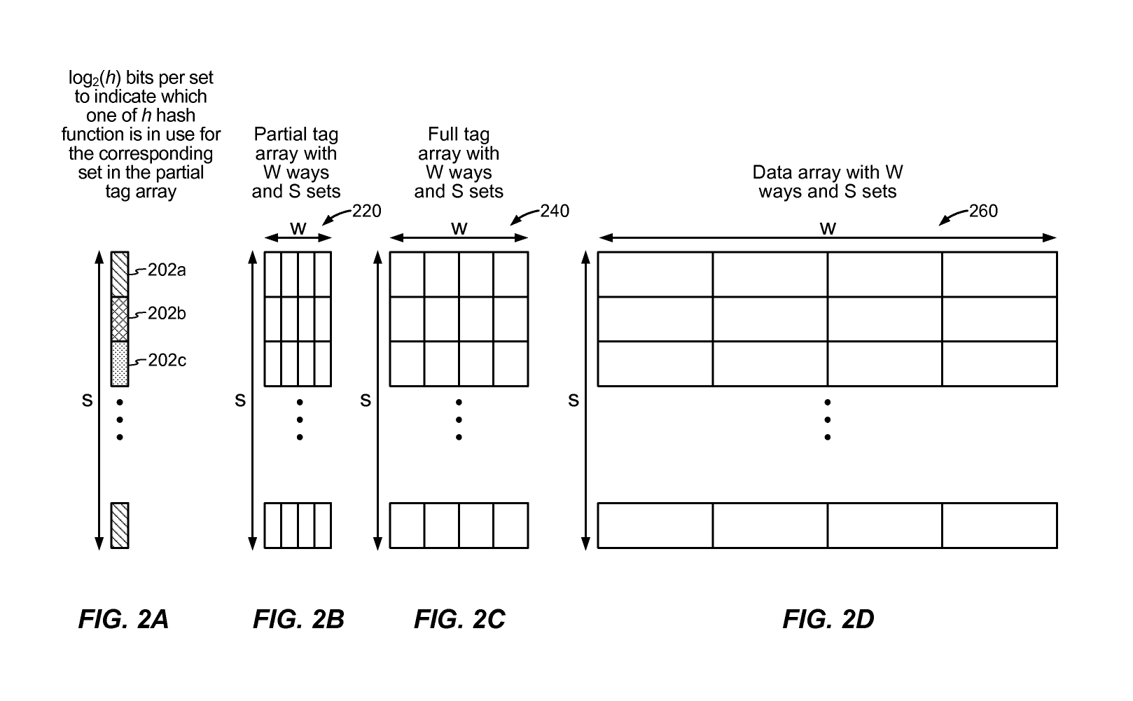

In an embodiment, a partial tag array with W number of ways and S number of sets is provided. In an embodiment, a plurality of partial tags may be extracted from a full line address using more than one hash function. FIGS. 2A-2D illustrate the relationships between per-set hash functions in a partial tag array, the partial tag array with W ways and S sets, the corresponding full tag array with W ways and S sets, and the corresponding data array with W ways and S sets, respectively.

In the embodiment shown in FIG. 2A, each of the sets 202a, 202b, 202c, . . . in a given way includes a number of bits depending on the number of hash functions for the corresponding set. For example, the number of bits per set may be log₂(h), where h is the number of hash functions for the corresponding set. The binary number in log₂(h) bits per set indicates which one of the h hash functions is in use for that set in the partial tag array. In the embodiment shown in FIG. 2B, a partial tag array 220 is formed by a two-dimensional array of W ways and S sets, in which each of the W ways includes S number of sets, such as sets 202a, 202b, 202c, . . . as shown in FIG. 2A. In an embodiment, a plurality of bits numbering log₂(h) bits are provided in each set to indicate which one of the h hash functions is in use for the set in the partial tag array.

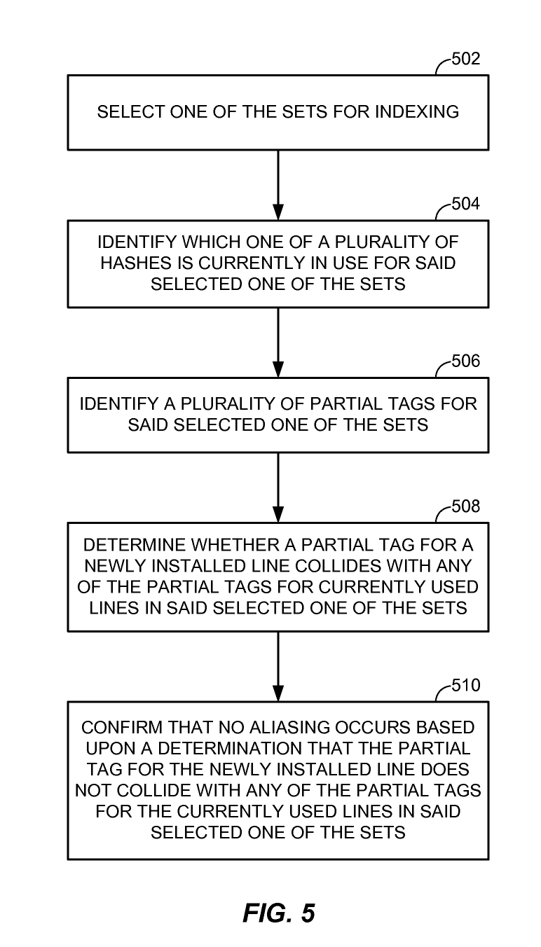

FIG. 2C illustrates an embodiment of a full tag array 240 with W ways and S sets, and FIG. 2D illustrates an embodiment of a data array 260 with W ways and S sets corresponding to the full tag array of FIG. 2C. The relationships between the partial tag array, the full tag array and the data array will be described in further detail below with respect to FIGS. 5-8.

In an embodiment, a plurality of relatively small partial tags are generated from a full line address. In an embodiment, each of the partial tags may be formed by concatenating a certain number of bits at a specific position from the full line address. Although concatenations of bits starting at specific positions in a full line address may be employed for generating multiple partial tags, other methods of forming partial tags from the full line address may also be used within the scope of the disclosure. In an embodiment, only one of a plurality of hashes may be employed for a given set at a given time. In an embodiment, each of the sets in the partial tag array retains the ability to identify which hash is currently in use for that set. In an ideal situation, no collision or aliasing occurs between a partial tag for a new line and any of the partial tags for other lines already in current use in that set.

On the other hand, if the partial tag for a line being new causes a collision or aliasing with any of the other partial tags currently in use in the set, then the partial tags for all the current lines in the set are recomputed based on the other hashes in use. In an embodiment, the full tags for all the lines in the set are read to resolve the collision or aliasing. It is desirable that such a reconfiguration in which readings of full tags for all the lines in the set are performed would be a rare event and be performed outside the critical path, for example, in the background. In an embodiment, all the full tags are hashed using various hash functions that are available, and one of the hashes that would result in minimal or no aliasing is selected as an alternate hash. If an alternate hash that minimizes or, better still, avoids collisions can be identified, the set updates all its partial tags accordingly, as well as the hash currently in use.

It is desirable that the partial tags need to be able to distinguish between h ways. Thus, ideally log₂(h) bits per partial tag should suffice. This corresponds to 2 bits per partial tag for a 4-way cache. In some typical examples of conventional configurations, however, up to 7 bits are used per partial tag, covering a space of 128 numbers, in order to distinguish between 4 ways. Even assuming that the request stream is independent and identically distributed, with the provision of 7 bits per partial tag, the collision rate still may be as high as 2.33%. In practice, request streams may exhibit pathological patterns, that is, they are not independent and identically distributed, which may result in higher collision rates even with the provision of 7 bits per partial tag. Instead of providing a large amount of storage required for large partial tags in an attempt to alleviate the problem of collision of aliasing, a limited amount of additional logic and occasional partial tag recomputation are provided in various aspects of the disclosure to reduce the amount of required storage and corresponding circuit area.

Given that partial tag computation is typically in the critical path of a cache lookup, it tends to not be able to exploit the full entropy available in the line address in conventional schemes. One approach to identifying the partial tag bits is to simply select a few bits from the full line address and concatenate these bits. This leaves room to exploit the remaining entropy in the full tag bits of a line address. In an embodiment, a plurality of bits are extracted from the full tag associated with a line address. In a further embodiment, it is desirable that the bits extracted from the full tag to form partial tags are non-overlapping and uncorrelated. Subsequently, the set of bits or hash that causes no collision or the least amount of collision for the current resident lines in the set is selected.

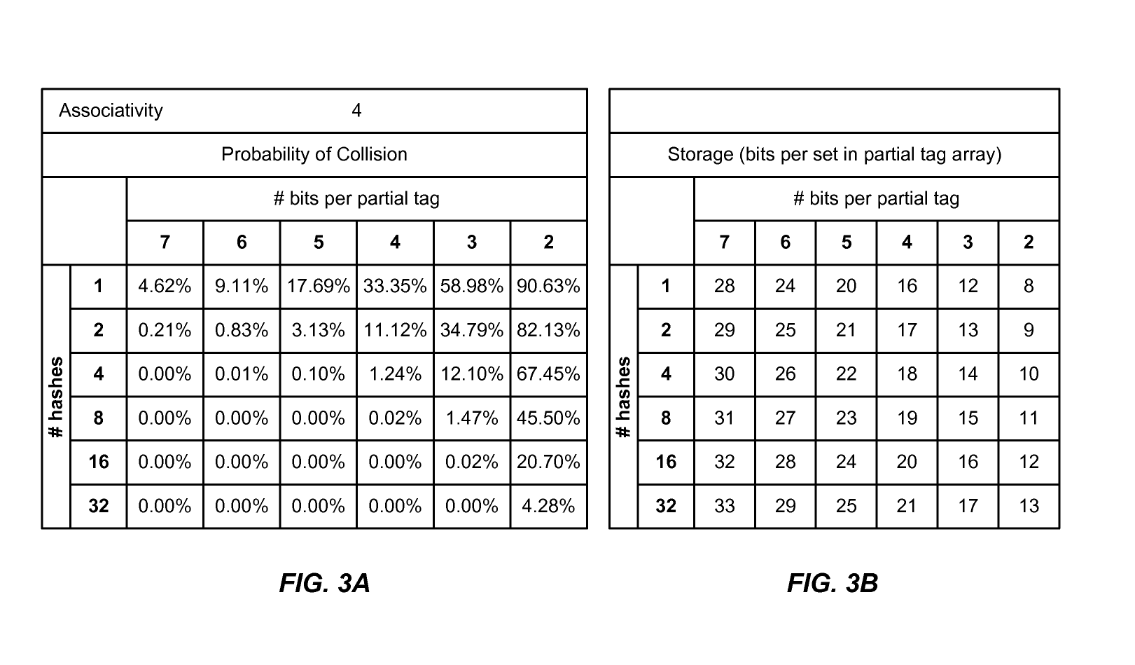

FIGS. 3A and 3B are exemplary tables illustrating the probability of collision and the storage bits per set, respectively, for a 4-way cache, that is, with an “associativity” of 4, as the number of hash functions and the number of bits per partial tag are varied. While it may not be possible to find 16 or more independent hash functions in a 40-bit tag, it may be possible to find 2, 4 or even 8 independent hash functions. For example, with a baseline design using 5 bits per partial tag array and a single hash function to identify the partial tags, the probability of collision is over 17%, and each partial tag array set needs 20 bits of storage, assuming that the request streams are independent and identically distributed. Alternatively, with 4 hash functions and 3 bits per partial tag, a lower collision rate of about 12% and a smaller 14 bit partial tag array set can be achieved. The collision rates may be higher if the request streams exhibit pathological patterns, that is, they are not independent and identically distributed. As illustrated in FIGS. 3A and 3B, increasing the storage to 4 bits per partial tag and 19 bits per set, the collision rate can be reduced to about 1.5%. Moreover, by simply adding support for a second hash function, that is, increasing the number of hashes from 1 to 2 for 5 bits per partial tag, the collision rate can be reduced from about 17% to about 3% with a very slight increase in the required storage from 20 bits per set to 21 bits per set.

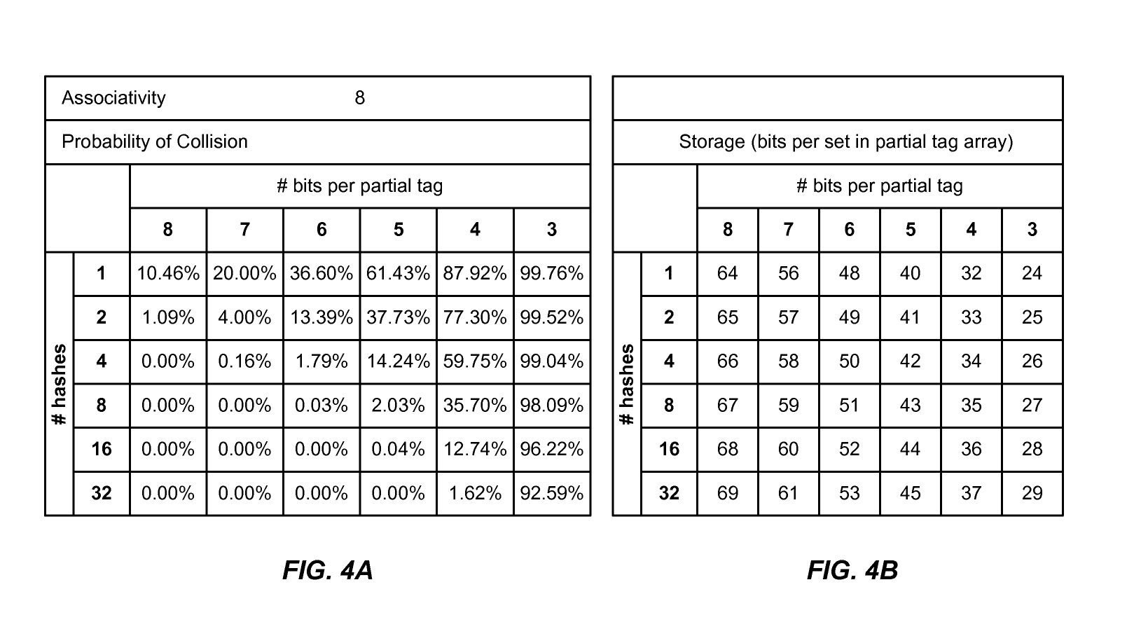

FIGS. 4A and 4B are exemplary tables illustrating the probability of collision and the storage bits per set, respectively, for an 8-way cache, that is, with an “associativity” of 8, as the number of hash functions and the number of bits per partial tag are varied. For example, with a baseline design uses 8 bits of partial tag per line, a probability of collision of about 10% is achieved by using 64 bits per partial tag array set, assuming that the request streams are independent and identically distributed. As described above, in practice the probability of collision may be higher due to pathological patterns in the request streams. As illustrated in FIGS. 4A and 4B, by using 4 hash functions instead of one and 6 bits instead of 8 bits per partial tag, the probability of collision is reduced to below 2% and the storage requirement is reduced from 64 bits to 50 bits per partial tag array set, thereby achieving a reduction of 22% in required storage. Thus, even in caches with higher associativity, the benefits of providing multiple partial tag hashes remain, as illustrated in the examples described with respect to FIGS. 4A and 4B.

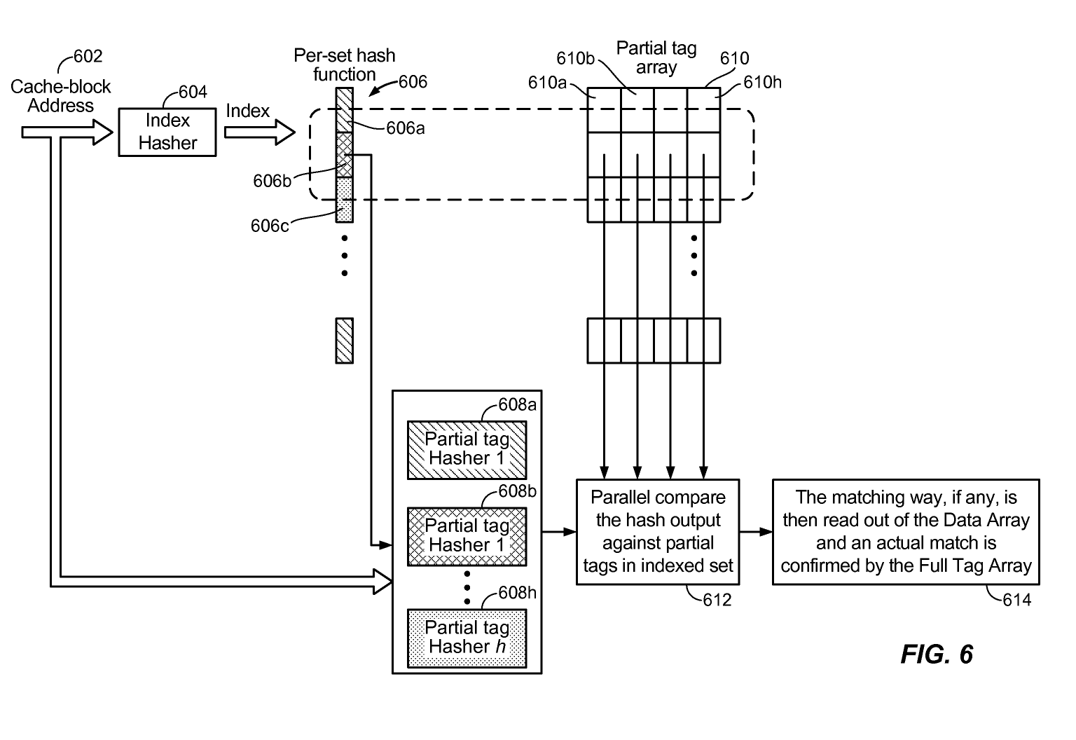

FIG. 5 is a flowchart illustrating an embodiment of a method of cache way prediction in a set-associative cache. In this embodiment, the set-associative cache has a full tag array with W number of ways and S number of sets and a corresponding data array with W number of ways and S number sets, as illustrated in FIGS. 2C and 2D described above. It is known that in the arts related to cache memory, a “way” is also called a “line,” and both terms are used interchangeably. In the embodiment shown in FIG. 5, one of the sets is selected or identified for indexing in block 502. In an embodiment, the set selected for indexing may be performed by an index hasher, embodiments of which will be described below with respect to FIGS. 6-8.

Referring to FIG. 5, after one of the sets is selected for indexing in block 502, one of a plurality of hashes that is currently in use for the selected set is identified in block 504. In an embodiment, the hash that is currently in use for the selected set is a full hash function for the selected set. In an embodiment, the has that is currently in use for the selected set may be identified by a per-set hash function identifier, embodiments of which will be described below with respect to FIGS. 6-8. Referring back to FIG. 5, after the hash that is currently in use for the selected set is identified in block 504, a plurality of partial tags are identified for the selected set in block 506.

In an embodiment, the partial tags may be generated or extracted from a full line address for the selected set. In an embodiment, the number of bits of each of the partial tags is fewer than the number of bits of a full line address, and each distinct partial tag may be formed by selecting more than one but fewer than all of the bits in the full line address and concatenating these selected bits. For example, the first or starting bit for each distinct partial tag may be selected from a different position in the full line address, and one or more other bits in the full line address may be selected in addition to the first or starting bit to form each distinct partial tag. The bits selected from the full line address for a given partial tag may or may not be consecutive bits in the full line address. In an embodiment, the partial tags may be extracted from a full line address in parallel to improve the speed of partial tag extraction.

It may be desirable that there is a high degree of independence between the different partial tags for the given set. Ideally, little or no correlation would exist between these partial tags to achieve a high level of entropy, that is, to minimize the probability of collision or aliasing. In practice, strict independence or non-correlation is not necessary in selecting the partial tags for cache way prediction, as long as the probability of collision or aliasing is acceptably low. Tradeoffs between the amount of storage required per set in a partial tag array and the number of hashes for 4-way and 8-way set-associative caches are described above with respect to exemplary tables shown in FIGS. 3A, 3B, 4A and 4B. For example, in a 4-way set-associative cache, if the probability of collision or aliasing needs to be below 1.24%, 4 bits per partial tag and 4 hashes may be chosen, with a required storage of 18 bits per set in the partial tag array, according to FIGS. 3A and 3B.

Referring back to FIG. 5, in an embodiment, after the partial tags for the selected set are identified in block 506, a determination is made as to whether a partial tag for a new line collides with any of the partial tags for current resident lines in the selected set in block 508. If it is determined that the partial tag for the new line does not collide with any of the partial tags for the current resident lines in the selected set, then it is confirmed that no aliasing occurs in block 510. In a further embodiment, an actual match between the new line and the corresponding line in the data array is confirmed by a full tag array, and if there is a match, then the data in the corresponding line in the data array is read out. Confirmation of the matching line using a full tag array and reading out of data in the data array may be performed in conventional manners known to persons skilled in the art.

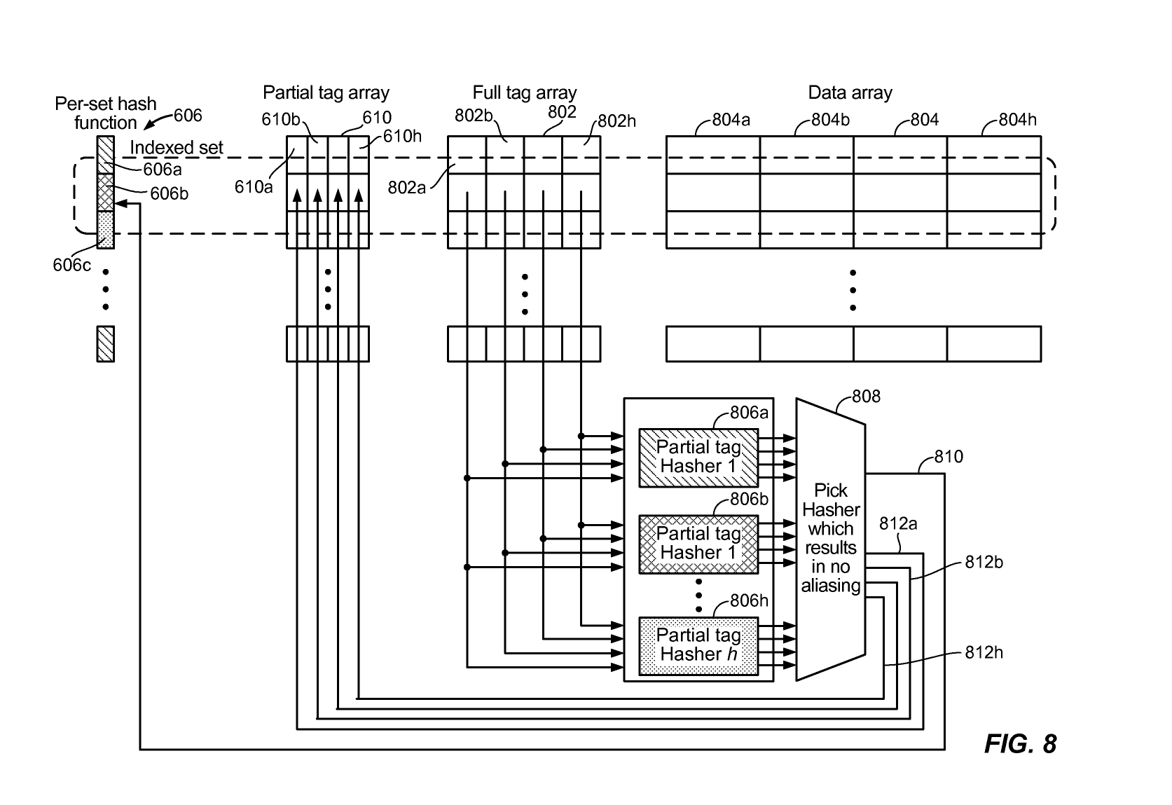

In an embodiment, if it is determined that the new line collides with any of the partial tags for the current resident lines in the selected set, thereby indicating an occurrence of aliasing, then the full tags for all of the lines in the selected set may be read and hashed by using various available hash functions. In an embodiment, one of the hash functions that results in no aliasing or at least a low probability of aliasing is selected. In a further embodiment, new partial tags associated with the newly selected hash function are generated. In an embodiment, the partial tag array is updated by replacing existing partial tags with these new partial tags to avoid or at least to reduce the probability of collision between the new line and the current resident lines. An embodiment of updating of partial tag array to avoid or to reduce the probability of aliasing will be described below with respect to FIG. 8.

FIG. 6 is a block diagram illustrating an embodiment of cache lookup using a partial tag array and partial tag hashers. In FIG. 6, a cache-block address 602 is received by an index hasher 604, which selects and indexes one of the sets in the cache block, which comprises a plurality of sets and a plurality of lines. After the set is selected and indexed by the index hasher 604, a per-set hash function 606 that is in use for the selected set is identified. In an embodiment, a plurality of partial tag hashers 608a, 608b, . . . 608h are provided based on the per-set hash function 606, which includes a plurality of hashers 606a, 606b, 606c, . . . . In an embodiment, one of the partial tag hashers 608a, 608b, . . . 608h is selected and exercised which corresponds to the hash function in use by the per-set hash function 606. For example, if the hasher 606b in the per-set hash function 606 is engaged to generate the partial tag for the incoming cache-block address 602, then only the output from the hasher 606b is compared in parallel against partial tags 610a, 610b, . . . 610h in the partial tag array 610.

Referring to FIG. 6, the partial tag array 610 having a plurality of partial tags 610a, 610b, . . . 610h may be generated based on the full line address of the set selected and indexed by the index hasher 604. In an embodiment, each of the partial tags may be formed by selecting some of the bits in the full line address in the selected and indexed set and concatenating those bits as described above. In a further embodiment, the partial tags are extracted from the full line address in parallel. Although it is desirable that the partial tags are highly independent of and uncorrelated with one another, it is not necessary in practice. One of the partial tag hashers 608a, 608b, . . . 608h engaged to generate partial tag hash output is transmitted to a comparator 612 for comparison against the partial tags 610a, 610b, . . . 610h in the partial tag array 610. In an embodiment, the comparator 612 performs comparisons of output from the engaged partial tag hasher against partial tags 610a, 610b, . . . 610h in the partial tag array 610 in parallel to improve the speed of processing. In an embodiment, a matching way, if any, is read out of the data array and an actual match is confirmed by the full tag array in block 614.

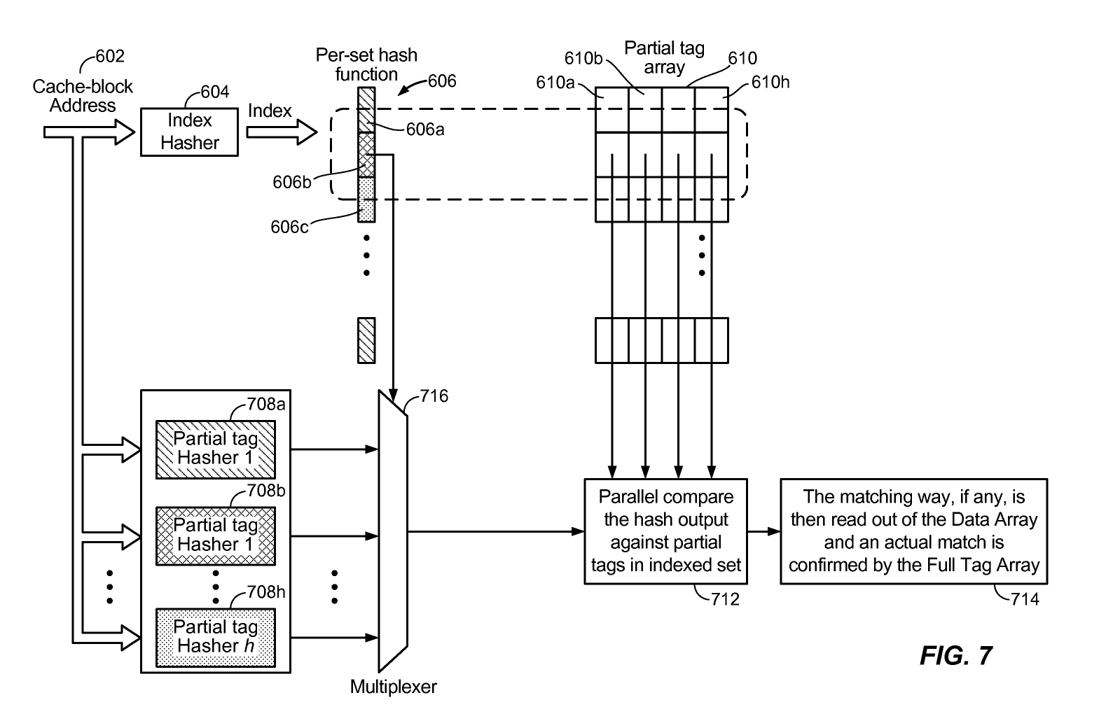

FIG. 7 is a block diagram illustrating an alternate embodiment of cache lookup using a partial tag array and partial tag hashers. In FIG. 7, a cache-block address 602 is received by an index hasher 604, which selects and indexes one of the sets in the cache block, which comprises a plurality of sets and a plurality of lines. In an embodiment, a plurality of partial tag hashers 708a, 708b, . . . 708h are also coupled to receive the cache-block address 602 and in response generate a plurality of partial tag hasher outputs. Instead of generating the partial tag hashers 608a, 608b, . . . 608h based on the per-set hash function 606 in the embodiment illustrated in FIG. 6 and described above, the partial tag hashers 708a, 708b, . . . 708h are generated by identifying all possible hash tags for the cache block being looked up, one partial tag hasher per hash function, in the embodiment illustrated in FIG. 7.

In FIG. 7, a multiplexer 716 is provided to multiplex the outputs of partial tag hashers 708a, 708b, . . . 708h based on a control input from the per-set hash function 606. The per-set hash function 606 may be identified based on the indexed set generated by the index hasher 604 in a similar manner to the embodiment illustrated in FIG. 6 and described above. Referring to FIG. 7, the per-set hash function 606 is used to identify and to select the hash function that is in use from the outputs of partial tag hashers 708a, 708b, . . . 708h. The selected hash tag output from the multiplexer 716 is then compared against the partial tags 610a, 610b, . . . 610h in the partial tag array 610. The partial tag array 610 in FIG. 7 may be generated in a similar manner to the embodiment illustrated in FIG. 6 and described above. For example, each of the partial tags 610a, 610b, . . . 610h may be formed by selecting some of the bits in the full line address in the selected set and concatenating those bits as described above. In an embodiment, a comparator 712 is provided to perform comparisons of the selected hash tag output from the multiplexer 716 against partial tags 610a, 610b, . . . 610h in the partial tag array in parallel. In an embodiment, only one of the hasher outputs corresponding to the hash function that is engaged to generate the partial tag is selected for output. In an embodiment, a matching way, if any, is read out of the data array and an actual match is confirmed by the full tag array in block 714.

FIG. 8 is a block diagram illustrating an embodiment of updating the partial tag array if it is determined that a collision or aliasing occurs between a new line from a received cache-block address and any of the current resident lines in the cache. In the embodiment shown in FIG. 8, the initial per-set hash function 606 and the initial partial tag array 610 comprising partial tags 610a, 610b, . . . 610h for the selected and indexed set may be generated in a similar manner to the embodiment shown in FIG. 6 and described above. In the embodiment shown in FIG. 8, a full tag array 802 having a plurality of full tags 802a, 802b, . . . 802h and a corresponding data array 804 having a plurality of data cells 804a, 804b, . . . 804h are also provided.

In an embodiment, all the full tags 802a, 802b, . . . 802h in the tag array 802 are read out only if aliasing is detected, that is, only if there is no collision between a new line in the received cache-block address and any of the current resident lines based on partial tag comparisons, embodiments of which are described above. In an embodiment, all the full tags are hashed using various hash functions available. For example, a plurality of partial tag hashers 806a, 806b, . . . 806h are provided in the embodiment illustrated in FIG. 8 to generate a plurality of hash outputs to a hasher selector 808, which picks one of the hashers that results in no aliasing or at least an acceptably low probability of aliasing. In an embodiment, the hasher selected by the hasher selector 808 is transmitted to the per-set hash function 606 through a path 810, and the per-set hash function 606 is updated with the selected hasher that results in no aliasing or at least an acceptably low probability of aliasing. In an embodiment, the selected hasher output from the hasher selector 808 overwrites the previous value stored in the per-set hash function 606.

In an embodiment, the hasher selector 808 also outputs a plurality of new partial tags associated with the newly selected hasher. In an embodiment, each of the new partial tags may be generated by selecting the first or starting bit and one or more additional bits from the newly selected hasher and concatenating these bits as described above, for example. In an embodiment, the new partial tags generated by the hasher selector 808 are transmitted to the partial tag array 610 through paths 812a, 812b, . . . 812h. Upon receiving the updated partial tags from the hasher selector 808, the partial tag array 610 updates its memory with new partial tags received from the hasher selector 808 by overwriting previous values stored in the partial tag array 610.

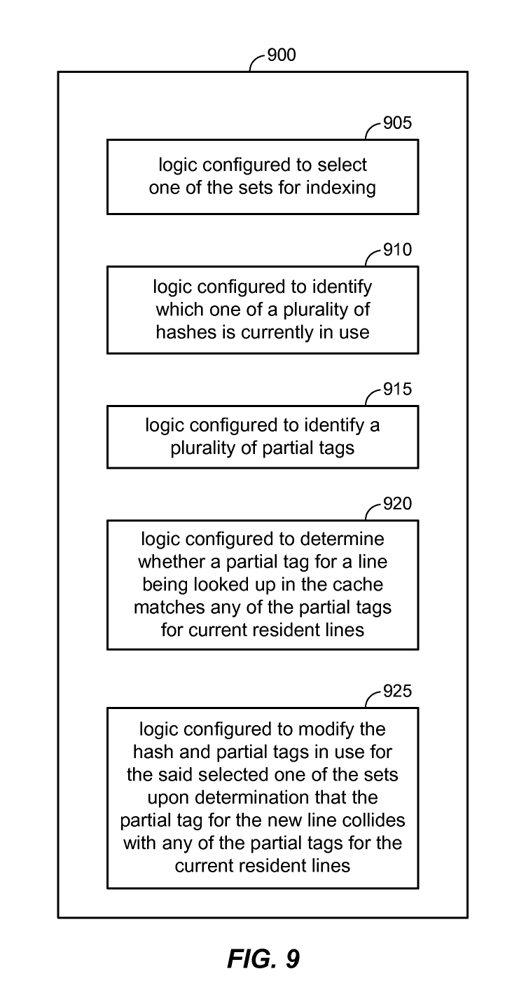

In an embodiment, an apparatus having a memory and a processor comprising logic configured to perform embodiments of process steps in any of the methods described above is provided. FIG. 9 illustrates an apparatus 900 that includes logic configured to perform functionalities in the embodiments described above. Referring to FIG. 9, the apparatus 900 includes logic configured to select one of the sets in a set-associative cache for indexing as shown in block 905. In the embodiment illustrated in FIG. 9, the apparatus 900 further includes logic configured to identify which one of a plurality of hashes is currently in use for the selected set as shown in block 910. In an embodiment, the apparatus 900 further includes logic configured to identify a plurality of partial tags for the selected set as shown in block 915. In an embodiment, the apparatus 900 further includes logic configured to determine whether a partial tag for a new line collides with any of the partial tags for current resident lines in the selected set as shown in block 920. In an embodiment, the apparatus 900 further includes logic configured to confirm that no aliasing occurs based upon a determination that the partial tag for the new line does not collide with any of the partial tags for the current resident lines in the selected set as shown in block 925.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware or a combination of hardware and software. Various illustrative components, blocks, modules, circuits, and steps have been described above generally in terms of their functionality. Whether such functionality is implemented as hardware or a combination of hardware and software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the embodiments disclosed herein may be embodied directly in hardware, or in a combination of hardware and a software module executed by a processor. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the disclosure can include a computer readable media embodying a method for cache way prediction using partial tags. Accordingly, the disclosure is not limited to illustrated examples and any means for performing the functionality described herein are included in embodiments of the disclosure.

While the foregoing disclosure shows illustrative embodiments, it should be noted that various changes and modifications could be made herein without departing from the scope of the appended claims. The functions, steps or actions of the method claims in accordance with embodiments described herein need not be performed in any particular order unless expressly stated otherwise. Furthermore, although elements may be described or claimed in the singular, the plural is contemplated unless limitation to the singular is explicitly stated.

What is claimed is:

1. A method of cache way prediction in a set-associative cache comprising a plurality of sets, each set comprising a plurality of lines, comprising:
selecting one of the sets for indexing;
identifying which one of a plurality of hashes is currently in use for said selected one of the sets;
identifying a plurality of partial tags for said selected one of the sets;
determining whether a partial tag for a line being looked up in the cache matches any of the partial tags for current resident lines in said selected one of the sets; and
when installing a new line in the cache, modifying the hash and partial tags in use for the said selected on of the sets upon a determination that the partial tag for the new line collides with any of the partial tags for the current resident lines in said selected one of the sets.

2. The method of claim 1, wherein selecting one of the sets for indexing comprises selecting said one of the sets for indexing using an index hasher.

3. The method of claim 1, further comprising generating a per-set hash function for said selected one of the sets.

4. The method of claim 3, further comprising generating a plurality of partial tag hashers using the per-set hash function.

5. The method of claim 1, further comprising reading full tags for all of the lines in said selected one of the sets based upon a determination that the partial tag for the new line collides with any of the partial tags for the current resident lines in said selected one of the sets.

6. The method of claim 1, further comprising extracting a plurality of distinct partial tags from an address of said selected one of the sets, the plurality of partial tags associated with a plurality of distinct hashes, respectively.

7. The method of claim 6, wherein the address comprises a full address for each of the sets, the full address comprising a plurality of bits.

8. The method of claim 7, wherein each of the partial tags comprises a plurality of bits few than the plurality of bits of the full address, further comprising:
selecting a plurality of bits from the full address; and
concatenating said selected plurality of bits to form each of the partial tags.

9. The method of claim 6, wherein extracting the plurality of distinct partial tags comprising extracting the plurality of distinct partial tags in parallel.

10. The method of claim 1, further comprising updating the partial tags in said selected one of the sets to reduce a probability of a collision between the new line and the current resident lines.

11. The method of claim 10, wherein updating the partial tags in said selected one of the sets to reduce the probability of a collision between the new line and the current resident lines comprises updating the partial tags in said selected one of the sets to avoid the collision between the new line and the current resident lines.

12. The method of claim 1, further comprising reading out a data array based upon the determination that the partial tag for the new line does not collide with any of the partial tags for the current resident lines in said selected one of the sets.

13. An apparatus for cache way prediction in a set-associative cache comprising a plurality of sets, each set comprising a plurality of lines, comprising:
means for selecting one of the sets for indexing;
means for identifying which one of a plurality of hashes is currently in use for said selected one of the sets;
means for identifying a plurality of partial tags for said selected one of the sets;
means for determining whether a partial tag for a line being looked up in the cache matches any of the partial tags for current resident lines in said selected one of the sets; and
means for modifying the hash and partial tags in use for the said selected on of the sets upon a determination that the partial tag for the new line collides with any of the partial tags for the current resident lines in said selected one of the sets when installing a new line in the cache.

14. The apparatus of claim 13, further comprising means for reading full tags for all of the lines in said selected one of the sets based upon a determination that the partial tag for the new line collides with any of the partial tags for current resident lines in said selected one of the sets.

15. The apparatus of claim 13, further comprising means for extracting a plurality of distinct partial tags from an address of said selected one of the sets, the plurality of partial tags associated with a plurality of distinct hashes, respectively.

16. The apparatus of claim 13, further comprising means for updating the partial tags in said selected one of the sets to reduce a probability of a collision between the new line and the current resident lines.

17. An apparatus for cache way prediction in a set-associative cache comprising a plurality of sets, each set comprising a plurality of lines, comprising:
logic configured to select one of the sets for indexing;
logic configured to identify which one of a plurality of hashes is currently in use for said selected one of the sets;
logic configured to identify a plurality of partial tags for said selected one of the sets;
logic configured to determine whether a partial tag for a line being looked up in the cache matches any of the partial tags for current resident lines in said selected one of the sets; and
logic configured to modify the hash and partial tags in use for the said selected on of the sets upon a determination that the partial tag for the new line collides with any of the partial tags for the current resident lines in said selected one of the sets when installing a new line in the cache.

18. The apparatus of claim 17, further comprising logic configured to read full tags for all of the lines in said selected one of the sets based upon a determination that the partial tag for the new line collides with any of the partial tags for current resident lines in said selected one of the sets.

19. The apparatus of claim 17, further comprising logic configured to extract a plurality of distinct partial tags from an address of said selected one of the sets, the plurality of partial tags associated with a plurality of distinct hashes, respectively.

20. The apparatus of claim 17, further comprising logic configured to update the partial tags in said selected one of the sets to reduce a probability of a collision between the new line and the current resident lines.
